(19) United States
(12) Patent Application Publication
(10) Pub. No.: US 2026/0255139 A1
(43) Pub. Date: Aug. 27, 2026

(54) IN-VEHICLE DEVICE

(71) Applicant: TOYOTA JIDOSHA KABUSHIKI KAISHA, Toyota-shi (JP)

(72) Inventors: Yuma ITO, Chiryu-shi (JP); Naoki UEDA, Nisshin-shi (JP); Shigeo OHNOGI, Aichi-gun (JP); Shingo SUGIMOTO, Nagoya-shi (JP); Isao NISHIOKA, Tokyo (JP)

(73) Assignee: TOYOTA JIDOSHA KABUSHIKI KAISHA, Toyota-shi (JP)

(21) Appl. No.: 19/442,068

(22) Filed: Jan. 7, 2026

(30) Foreign Application Priority Data
Feb. 27, 2025 (JP) 2025-030750

(51) Int. Cl. H04W 4/46; H04L 43/12

(52) U.S. Cl. CPC H04W 4/46; H04L 43/12

(57) ABSTRACT

The in-vehicle device includes a communication unit capable of wireless communication by cellular communication and vehicle-to-vehicle communication, and a control unit that enables or disables cellular communication by the communication unit according to information acquired from the server. When the cellular communication is disabled, the control unit acquires first information for enabling the cellular communication from the server via the other vehicle through the vehicle-to-vehicle communication, and enables the cellular communication.

### CROSS-REFERENCE TO RELATED APPLICATION

This application claims priority to Japanese Patent Application No. 2025-030750 filed on February 27, 2025. The disclosure of the above-identified application, including the specification, drawings, and claims, is incorporated by reference herein in its entirety.

### BACKGROUND

### 1. Technical Field

The present disclosure relates to an in-vehicle device.

### 2. Description of Related Art

Techniques relating to wireless communication of vehicles are known. For example, there is disclosed a wireless communication device mounted on a vehicle, the wireless communication device transmitting a data packet using a channel selected from among a plurality of available channels.

### SUMMARY

There is room for improvement in wireless communication pattern of a vehicle.

The present disclosure has been made in view of the above circumstances, and an object of the present disclosure is to improve a wireless communication pattern of a vehicle.

An aspect of the present disclosure provides an in-vehicle device mounted on a vehicle, including: a communication unit that enables wireless communication through cellular communication and vehicle-to-vehicle communication; and a control unit that enables or disables the cellular communication by the communication unit according to information acquired from a server, in which when the cellular communication is disabled, the control unit enables the cellular communication when the control unit acquires first information for enabling the cellular communication from the server via a different vehicle through the vehicle-to-vehicle communication.

According to the aspect of the present disclosure, it is possible to improve a wireless communication pattern of a vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a schematic configuration of an in-vehicle device according to the present disclosure;

FIG. 2 is a flowchart showing the normal operation of the in-vehicle device; and

FIG. 3 is a flowchart illustrating an operation of the in-vehicle device according to the present disclosure.

### DETAILED DESCRIPTION OF EMBODIMENTS

Hereinafter, an embodiment of the present disclosure will be described.

### Outline of Embodiment

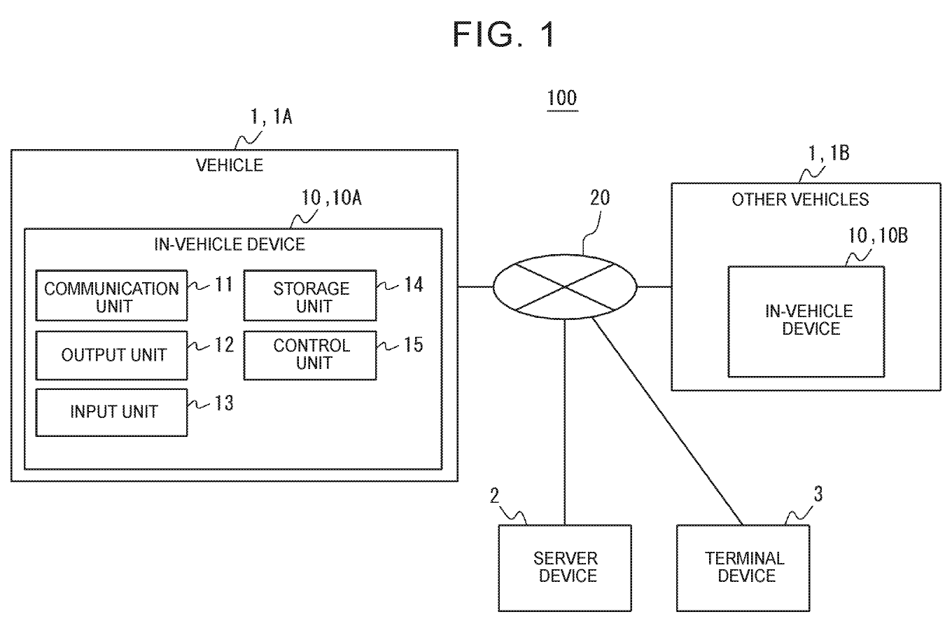

FIG. 1 is a diagram illustrating a configuration of a vehicle system according to an embodiment. The vehicle system 100 includes a plurality of in-vehicle devices 10 and one or more server devices 2 that are connected to each other via a network 20 so as to be able to communicate information with each other. Each in-vehicle device 10 is mounted on the vehicle 1. The vehicle 1 is an arbitrary vehicle such as an automobile or a two-wheeled vehicle. The in-vehicle device 10 is an information processing device having a communication function, and includes, for example, a Data Communication Module (DCM), a car navigation device, a drive recorder, an Electronic Control Unit (ECU), and the like. Hereinafter, the in-vehicle device 10A, 10B is referred to when the plurality of in-vehicle devices 10 are distinguished, and the vehicle 1A, 1B is referred to when the plurality of vehicles 1 are distinguished. The network 20 is a vehicle-to-vehicle communication using a radio Wireless Local Area Network (LAN) such as cellular communication or Wi-Fi (registered trademark). The server device 2 is, for example, a server computer belonging to a cloud computing system or other computing system and implementing various functions. Further, a plurality of terminal devices 3 used by the user of the vehicle 1 are connected to the network 20 so as to be capable of information communication. The terminal device 3 is, for example, an information processing device having a communication function such as a Personal Computer (PC) or a smart phone.

The in-vehicle device 10 according to the present embodiment includes a communication unit 11 capable of wireless communication by cellular communication and inter-vehicle communication, and a control unit 15 that enables or disables cellular communication by the communication unit 11 in accordance with information acquired from the server. When the cellular communication is disabled, the control unit 15 acquires first information (hereinafter, referred to as cellular communication enabling information) for enabling the cellular communication from the servers via the other vehicle 1B by vehicle-to-vehicle communication, and enables the cellular communication. For example, in the wireless communication contract of the vehicle 1, it is assumed that a free period in which the customer does not need to bear the cellular communication cost is defined for three years from the time of the contract. In this case, it is conceivable that the cellular communication of the vehicle 1 is disabled unless the owner of the vehicle 1 (hereinafter referred to as a user) makes a contract for continuing the wireless communication by the end of the free period. However, when the cellular communication of the vehicle 1 is invalidated, how to transmit the cellular communication enabling information of the vehicle 1 to the vehicle 1 becomes a problem in a case where the user makes a re-contract of the wireless communication. At this time, according to the present embodiment, the in-vehicle device 10 disables the cellular communication. Even in this case, the cellular communication enabling information can be acquired by the inter-vehicle communication, and the cellular communication can be enabled. Therefore, the wireless communication pattern of the vehicle can be improved.

As illustrated in FIG. 1, the in-vehicle device 10 includes an output unit 12, an input unit 13, and a storage unit 14 in addition to the communication unit 11 and the control unit 15. Hereinafter, a part provided in the in-vehicle device 10A is referred to as a communication unit 11A, an output unit 12A, an input unit 13A, a storage unit 14A, and a control unit 15A, and a part provided in the in-vehicle device 10B is referred to as a communication unit 11B, an output unit 12B, an input unit 13B, a storage unit 14B, and a control unit 15B.

The communication unit 11 includes two or more communication interfaces that enable cellular communication, inter-vehicle communication, and the like. Communication interfaces include, for example, 4th Generation (4G), 5th Generation (5G), mobile communication standards used for cellular communications, and near field communication standards used for inter-vehicle communications, such as Wi-Fi, Bluetooth. The communication unit 11 communicates with the server device 2, the terminal device 4, and other in-vehicle device 10B in the vicinity through the network 20.

The output unit 12 includes one or more output devices for outputting information. The output device includes, for example, a display for outputting an image and a speaker for outputting sound.

The input unit 13 includes one or more input devices that detect an input operation by a user. The input device includes, for example, a physical key, a capacitive key, a touch panel, a touch screen integrally provided with a display of the output unit 12, a microphone, and the like.

The storage unit 14 includes one or more memories. The memory is, for example, a semiconductor memory, a magnetic memory, an optical memory, or the like. Each memory included in the storage unit 14 may function as, for example, a main storage device, an auxiliary storage device, or a cache memory. The storage unit 14 stores arbitrary information used for the operation of the in-vehicle device 10. For example, the storage unit 14 stores a profile used when the control unit 15 enables or disables the cellular communication of the communication unit 11. Further, for example, the storage unit 14 may store a system program, an application program, embedded software, and the like. For example, information stored in the storage unit 14 may be updatable by information acquired from the network 20 via the communication unit 11, for example

The control unit 15 includes one or more processors, one or more programmable circuits, one or more dedicated circuits, or a combination of these. The processor may be, but is not limited to, a general-purpose processor such as, for example, Central Processing Unit (CPU) or Graphics Processing Unit (GPU), or a special-purpose processor specialized for a particular process. The programmable circuitry is, for example, but not limited to, Field-Programmable Gate Array (FPGA). The dedicated circuitry is, for example, an Application Specific Integrated Circuit (ASIC). The control unit 15 controls the operation of the in-vehicle device 10.

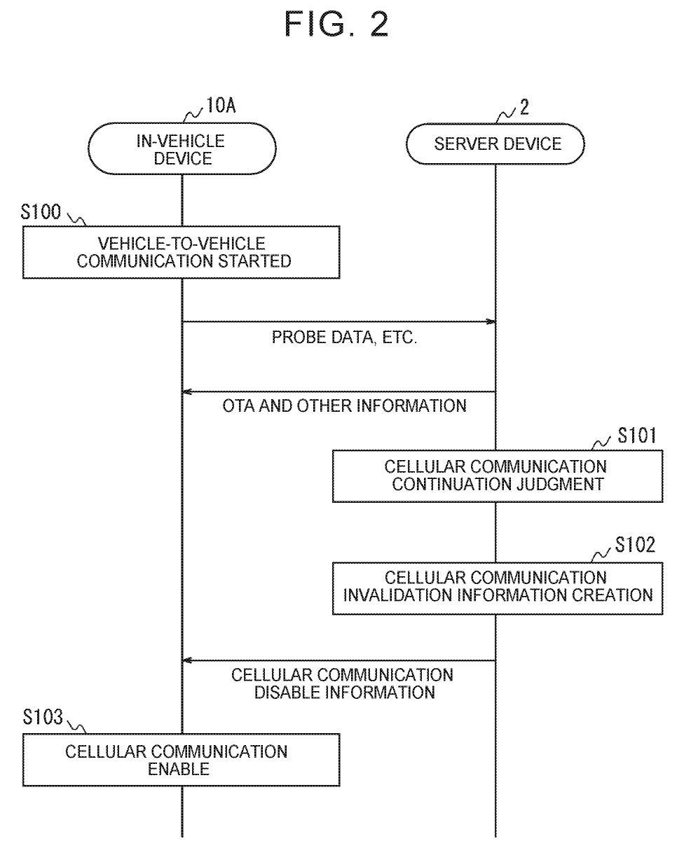

FIG. 2 is a sequence diagram for describing an example of a procedure related to the cooperative operation of the in-vehicle device 10 and the server device 2 when the cellular communication of the communication unit 11 of the in-vehicle device 10 is enabled. The procedure of FIG. 2 is executed when the in-vehicle device 10 is activated after the vehicle 1 is delivered to the user. In the procedure of FIG. 2, it is assumed that the cellular communication of the communication unit 11 is enabled when the vehicle 1 is delivered to the user, but the procedure is also applied to a case where the cellular communication of the communication unit 11 is disabled when the vehicle 1 is delivered to the user. In this case, in order to execute the procedure of FIG. 2, it is necessary to implement the present embodiment described later.

The control unit 15 of the in-vehicle device 10 starts cellular communication with the server device 2 using the communication unit 11 (S100). When the cellular communication is started, the control unit 15 transmits necessary data to the server device 2, such as probe data of the vehicle 1, to the server device 2, and receives data necessary for the operation of the vehicle 1 such as OTA data from the server device 2. The data transmitted and received between the in-vehicle device 10 and the server device 2 is not limited to the data required by the vehicle 1 or the server device 2, and includes data used for entertainment such as distribution of music. The transmission and reception of data between the in-vehicle device 10 and the server device 2 is performed each time a necessity occurs. When data transmission/reception with the in-vehicle device 10 is performed, the server device 2 acquires the cellular communication contract status information of the user from the storage unit of the server device 2, and determines whether or not the cellular communication with the in-vehicle device 10 may be continued (S101). The cellular communication contract status information is information indicating whether or not the user's cellular communication contract is valid. For example, when the subscription period of the cellular communication of the user has ended, the cellular communication subscription status information includes information indicating that the subscription of the cellular communication of the user is invalid. When the contract for the cellular communication is valid, the server device 2 continues to transmit and receive data to and from the in-vehicle device 10 by the cellular communication. On the other hand, in the server device 2, the contract for the cellular communication is invalid. Here, information for disabling the cellular communication including, for example, an activation waiting profile in which the cellular communication is invalid (hereinafter, referred to as "cellular communication disabling information") is created and transmitted to the in-vehicle device 10 (S102). Upon receiving the cellular communication invalidation information, the control unit 15 rewrites the profile stored in the storage unit 14 from the normal profile in which the cellular communication is enabled to the activation waiting profile. As a result, the cellular communication of the communication unit 11 is disabled (S103).

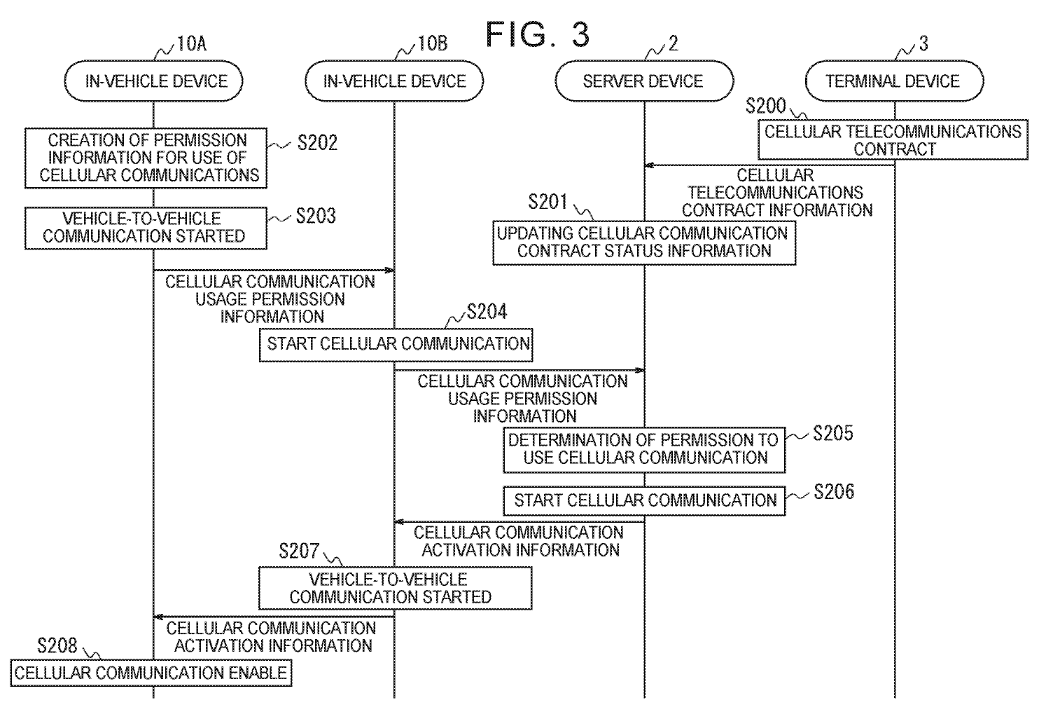

FIG. 3 is a sequence diagram for explaining an exemplary sequence of a cooperative operation of the in-vehicle device 10A, the in-vehicle device 10B, the server device 2, and the terminal device 3 in the present embodiment when the cellular communication of the communication unit 11A of the in-vehicle device 10A is disabled. When the user uses the terminal device 3 to make a cellular communication contract for the vehicle 1A, the terminal device 3 transmits information related to the cellular communication contract (hereinafter, referred to as cellular communication contract information) to the server device 2 (S200). Upon receiving the cellular communication contract information, the server device 2 updates the cellular communication contract of the cellular communication contract status information of the user to be effective (S201). The user can also make a cellular communication contract for the vehicle 1A in writing, for example, at a store, without using the terminal device 3 of the user. In this case, the store clerk transmits the cellular communication contract information to the server device 2 using the terminal device 3 of the store. Next, when the user requests the use of the cellular communication of the vehicle 1A using the in-vehicle device 10A, the control unit 15A creates second information (hereinafter, referred to as cellular communication use permission information) indicating the use request of the cellular communication (S202). The user requests the use of the cellular communication of the vehicle 1A, for example, by the user performing a predetermined manipulation by the input unit 13A from a screen displayed on the display of the output unit 12A using an application stored in the storage unit 14A. The control unit 15A monitors whether or not there is another vehicle 1B capable of

inter-vehicle communication, and performs inter-vehicle communication with the in-vehicle device 10B of the other vehicle 1B when the other vehicle 1B is detected. The cellular communication use permission data of the vehicle 1A addressed to the server device 2 is transmitted to the in-vehicle device 10B (S203). Upon receiving the cellular communication use permission information of the vehicle 1A, the control unit 15B of the in-vehicle device 10B performs cellular communication with the server device 2, and transmits the cellular communication use permission information of the vehicle 1A to the server device 2 (S204). Upon receiving the cellular communication use permission information of the vehicle 1A, the server device 2 acquires the cellular communication contract status information of the user and determines whether or not the cellular communication use of the in-vehicle device 10A may be permitted (S205). When the contract for the cellular communication of the user is valid, the server device 2 performs the cellular communication with the in-vehicle device 10B, and transmits the cellular communication enabling data including, for example, the normal profile of the in-vehicle device 10A to the in-vehicle device 10B (S206). Upon receiving the cellular communication enabling information, the control unit 15B performs inter-vehicle communication with the in-vehicle device 10A, and transmits the cellular communication enabling information of the in-vehicle device 10A to the in-vehicle device 10A (S207). Upon receiving the cellular communication activation data, the control unit 15A activates the cellular communication of the communication unit 11 by rewriting the profile stored in the storage unit 14 from the activation waiting profile to the normal profile (S208).

IP addressing may be used by the server device 2 to identify the in-vehicle device 10. However, when the communication line of the connection destination is different, IP addressing is also different. For this reason, the communication unit 11 may use a unique IP address for the cellular communication and the vehicle-to-vehicle communication by using a mobile communication protocol such as Mobile IP.

Further, for example, in the above-described embodiment, the cellular communication is disabled in the communication unit 11A. At this time, data required by the server device 2, such as probe data of the vehicle 1A, may be transmitted to the server device 2 via the other vehicle 1B by vehicle-to-vehicle communication. When the cellular communication is disabled, the communication unit 11A may receive data required for the operation of the vehicle 1, such as OTA data, from the server device 2 via the other vehicle 1B by vehicle-to-vehicle communication. This is because such data needs to be exchanged even when the cellular communication is disabled.

Further, for example, in the above-described embodiment, S202 may be executed by the terminal device 3. In this case, S203 and S204 are not performed, and the terminal device 3 transmits the cellular communication use permission information of the vehicle 1A to the server device 2. S202 may be executed concurrently with S200. When the contract for the cellular communication of the user is valid in S205, the server device 2 specifies the in-vehicle device 10A to which the cellular communication enabling information is transmitted from the vehicle ID or the user ID included in the cellular communication use permission information. The server device 2 identifies the other vehicle 1B that is performing inter-vehicle communication with the in-vehicle device 10A in S206, and transmits the cellular communication enabling data to the in-vehicle device 10B. For example, the server device 2 may identify a vehicle of a user having an address close to that of the user of the vehicle 1A as another vehicle 1B, and may identify a vehicle that has performed vehicle 1A and vehicle-to-vehicle communication in the immediate vicinity as another vehicle 1B.

Further, in the above-described embodiment, for example, a general-purpose computer can function as the in-vehicle device 10 according to the above-described embodiment. Specifically, a program describing processing contents for realizing each function of the in-vehicle device 10 according to the above-described embodiment is stored in a memory of a general-purpose computer, and the program is read and executed by a processor. Therefore, the present disclosure can also be realized as a program that can be executed by the processor or a non-transitory computer-readable medium that stores the program.

Although the present disclosure has been described above based on the drawings and the embodiment, it should be noted that those skilled in the art may make various modifications and alterations thereto based on the present disclosure. It should be noted, therefore, that these modifications and alterations are within the scope of the present disclosure. For example, the functions included in the configurations, steps, etc. can be rearranged so as not to be logically inconsistent, and a plurality of configurations, steps, etc. can be combined into one or divided.

What is claimed is:

1. An in-vehicle device mounted on a vehicle, comprising:
a communication unit that enables wireless communication through cellular communication and vehicle-to-vehicle communication; and
a control unit that enables or disables the cellular communication by the communication unit according to information acquired from a server, wherein
when the cellular communication is disabled, the control unit enables the cellular communication when the control unit acquires first information for enabling the cellular communication from the server via a different vehicle through the vehicle-to-vehicle communication.

2. The in-vehicle device according to claim 1, wherein the communication unit transmits probe data of the vehicle to the server through the cellular communication when the cellular communication is enabled, and transmits the probe data to the server via the different vehicle through the vehicle-to-vehicle communication when the cellular communication is disabled.

3. The in-vehicle device according to claim 1, wherein the first information is sent in response to the server receiving second information indicating that an owner of the vehicle is requesting to use the cellular communication.

4. The in-vehicle device according to claim 3, wherein the communication unit transmits the second information to the server via the different vehicle through the vehicle-to-vehicle communication.

5. The in-vehicle device according to claim 1, wherein the communication unit uses a unique IP address for the cellular communication and the vehicle-to-vehicle communication.
